(19) United States
(12) Patent Application Publication
(10) Pub. No.: US 2014/0069349 A1
(43) Pub. Date: Mar. 13, 2014

(54) SONIC STICK

(71) Applicants: Michael Croix, Seattle, WA (US); Christopher Lee, Central Hong Kong (HK)

(72) Inventors: Michael Croix, Seattle, WA (US); Christopher Lee, Central Hong Kong (HK)

(21) Appl. No.: 13/780,749

(22) Filed: Feb. 28, 2013

Related U.S. Application Data
(60) Provisional application No. 61/604,371, filed on Feb. 28, 2012.

(51) Int. Cl. A01K 15/02; B29C 45/00; B29C 41/04

(52) U.S. Cl. CPC A01K 15/025; B29C 41/04; B29C 45/00
USPC 119/707; 264/311; 29/896.2

(57) ABSTRACT

A sonic stick apparatus includes a housing that includes one or more hollow cylinders (and/or other shaped tubes), defining one or more housing passages. The housing has at least a first and a second aperture and includes one or more airflow disruption members positioned between the first and second apertures. When the housing is manipulated to cause air to flow through the housing passage, the airflow is disrupted by the airflow disruption member, producing one or more sounds. In some implementations, the airflow disruption member may include a disc with one or more airflow disruption member apertures. Such a sonic stick apparatus may be produced by providing the housing and positioning one or more airflow disruption members within one or more housing passages. In one or more implementations the airflow disruption member may be positioned within the housing passages by inserting the airflow disruption member into the housing.

### CROSS REFERENCE TO RELATED APPLICATIONS

This application claims the benefit of U.S. Provisional Patent Application No. 61/604,371 filed Feb. 28, 2012, which is incorporated herein by reference in its entirety.

### FIELD OF THE INVENTION

This disclosure relates generally to toys, and more specifically to a sonic stick such as a sound-producing pet toy.

### BACKGROUND

Pet owners may utilize a variety of different types of toys in order to interact with their pets. Such toys may include a number of different features for engaging different sensory organs of the pets. For example, toys may have a variety of textures and consistencies in order for the pets to be able to grip the toys, bite the toys, chew the toys, and otherwise physically and/or tactilely interact with the toys. Additionally, toys may be designed to be thrown and/or otherwise moved by the pet owner or other means of physical motion in order to interact with the visual senses of pets and/or instincts of pets to chase. Moreover, toys may produce scents in order to interact with olfactory organs of pets, include lights and/or moving parts in order to interact with the visual senses of pets, possess or more taste-able elements for interactive with the sense of taste of pets, include electrical audio elements for producing sounds to interact with auditory organs of pets, and/or include other features for otherwise interacting with sensory organs of the pets. By interacting with pets utilizing multiple types of sensory experiences, the interest of pets may be increased in toys.

Pets may prefer toys that produce sounds. However, many sound-producing pet toys rely on electrical sound components that a bulky, fragile, expensive, and require batteries. Some pet toys rely on squeezable squeaker devices in order to produce sound without relying on electrical sound components. Such squeezable squeaker devices may not be as bulky, fragile, expensive, as electronic sound producing components. Further, squeezable squeaker devices may not require batteries. However, unlike electrical sound components, squeezable squeaker devices may not produce sound until interacted with by a pet. As such, such squeezable squeaker devices may not attract much pet interest as the devices do not produce sounds unless a pet is already interacting with a toy and is thus already attracted to the toy. Though both electrical sound components and squeezable squeaker devices have advantages when utilized in pet toys, both also have disadvantages.

### SUMMARY

The present disclosure discloses a sonic stick apparatus and methods for producing a sonic stick apparatus. The sonic stick apparatus may include a housing member that may include one or more hollow cylinders (and/or other shaped tubes), defining one or more housing member passages. The housing member may have at least a first and a second aperture and may include one or more airflow disruption members positioned between the first and second apertures. The housing member may be configured such that the sonic stick apparatus floats in water. Such configuration may include one or more hollow foam tubes inserted into the housing member passages, construction of the housing member from a buoyant material, adding a buoyant collar to the housing member, and/or any other such means of causing the sonic stick to be buoyant. When the housing member is manipulated to cause air to flow through the housing member passage, the airflow may be disrupted by the airflow disruption member, producing one or more sounds. In some implementations, the airflow disruption member may include a disc with one or more airflow disruption member apertures.

Such a sonic stick apparatus may be produced by providing the housing member and positioning one or more airflow disruption members within one or more housing member passages. In various implementations, the housing member may be provided by rotation molding a material such as polyvinyl chloride. In some implementations, the airflow disruption member may be produced by injection molding. In one or more implementations the airflow disruption member may be positioned within the housing member passages by inserting the airflow disruption member into the housing member after the housing member has been heated to expand and sealing the airflow disruption member into place utilizing glue and/or another sealant. The housing member may be molded to include one or more ring members that may brace the airflow disruption member when the airflow disruption member is inserted into the housing member.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is a front plan view of a first implementation of a sonic stick.

FIG. 1B is a right side plan view of the sonic stick of FIG. 1A illustrating a cross section taken along the line 1-1 of FIG. 1A.

FIG. 1C is a top plan view of the sonic stick of FIG. 1A illustrating a cross section taken along the line 2-2 of FIG. 1A.

FIG. 1D is a bottom isometric view of the sonic stick of FIG. 1A.

FIG. 1E is a front plan exploded view of the sonic stick of FIG. 1A.

FIG. 2 is an isometric front view of a second implementation of a sonic stick.

FIG. 3 is a flow chart illustrating a method for providing a sonic stick.

### DETAILED DESCRIPTION OF THE EMBODIMENTS

The description that follows includes sample apparatuses and methods that embody various elements of the present disclosure. However, it should be understood that the described disclosure may be practiced in a variety of forms in addition to those described herein.

The present disclosure discloses a sonic stick apparatus and methods for producing a sonic stick apparatus. The sonic stick may include a housing member that may include one or more hollow cylinders, defining one or more housing member passages. The housing member may have at least a first and a second aperture and may include one or more airflow disruption members positioned between the first and second apertures. When the housing member is manipulated to cause air to flow through the housing member passage, the airflow may be disrupted by the airflow disruption member, producing one or more sounds. In some implementations, the airflow disruption member may include a disc with one or more airflow disruption member apertures.

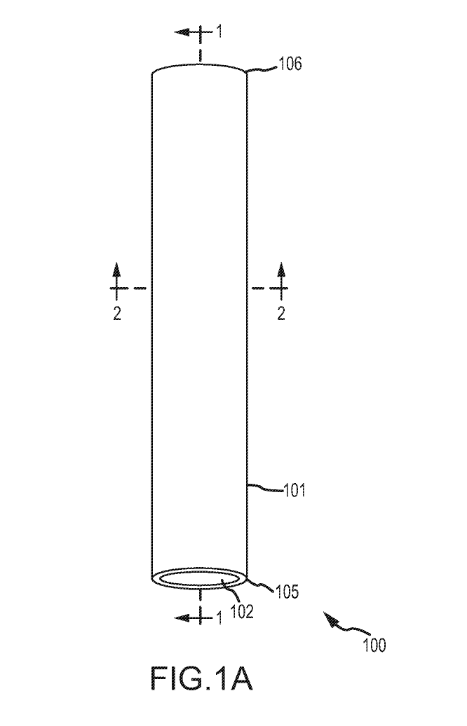

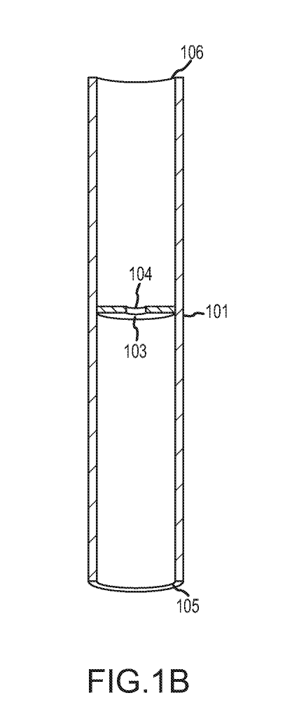

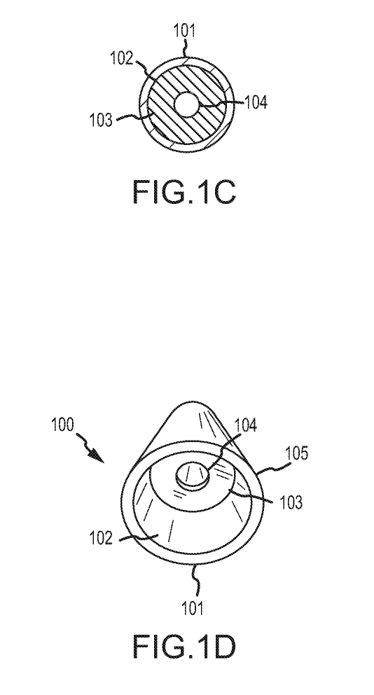

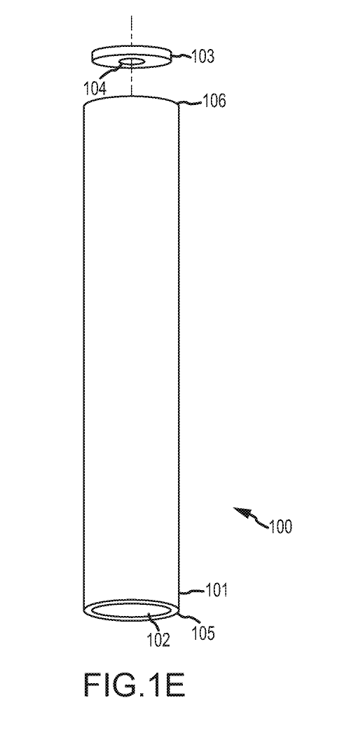

FIG. 1A is a front plan view of a first implementation of a sonic stick 100. The sonic stick may include a housing member 101. The housing member 101 may be a hollow cylinder (and/or other shaped tube) that defines a cylindrical (and/or other shaped) housing member passage 102 (i.e., a hollow passage) within the housing member 101. The housing member 101, and therefore cylindrical housing member passage 102 defined by the housing member 101, may have length and width wherein the length is greater than the width. As shown, the length of the housing member 101 may be between a first end 105 and a second end 106. The hollow cylinder may include a first aperture at the first end 105 of the housing member passage 102 and a second aperture at the second end 106 of the housing member passage 102.

The housing member 101 may be manipulated (such as held by the first end 105 and/or the second end 106 and swung in an arc and/or other motion). Such manipulation may cause air to flow through the housing member passage 102. The manipulation may cause air to flow through the housing member passage 102 from the first aperture at the first end 105 of the housing member passage 102 toward the second aperture at the second end 106 of the housing member passage 102. Alternatively, the manipulation may cause air to flow through the housing member passage 102 from the second aperture at the second end 106 of the housing member passage 102 toward the first aperture at the first end 105 of the housing member passage 102.

One or more airflow disruption members may be positioned within the housing member passage 102 (such as the airflow disruption member 103 shown in FIGS. 1B-1E). The airflow disruption member may be positioned such that airflow from the first aperture to the second aperture is disrupted (i.e., turbulence is caused) and/or airflow from the second aperture to the first aperture is disrupted (i.e., turbulence is caused). Such disruption of the airflow (i.e., turbulence) may produce one or more sounds. Such disrupted airflow may produce sounds in a similar manner to the operation of a whistle.

FIG. 1C is a top plan view of the sonic stick 100 of FIG. 1A illustrating a cross section taken along the line 2-2 shown in FIG. 1A. An airflow disruption member 103 may be positioned within the housing member passage 102 to correspond with the line 2-2 shown in FIG. 1A such that a cross-section of the airflow disruption member 103 is visible in FIG. 1C. As is illustrated, the airflow disruption member 103 may be a disc with a diameter that is substantially similar to the diameter of the housing member passage 102 (such as a diameter that is equal to the diameter of the housing member passage 102 such that the airflow disruption member 103 completely obstructs the housing member passage or smaller than the diameter of the housing member passage 102 such that the airflow disruption member 103 obstructs most but not completely all of the housing member passage 102).

In some cases, the diameter of the airflow disruption member 103 may be equal to the diameter of the housing member passage 102 and the airflow disruption member 103 may be positioned by being wedged into place in the housing member passage 102. In other cases, the diameter of the airflow disruption member 103 may be smaller than the diameter of the housing member passage 102, resulting in one or more gaps between the airflow disruption member 103 and the housing member 101, and the airflow disruption member 103 may be positioned by being placed in the housing member passage 102 and the one or more gaps sealed with one or more sealants such as epoxy and/or other glues, one or more polymers, and/or other such sealants. In other cases, a sealant may not be utilized and the one or more gaps may be sealed by directly melding the airflow disruption member 103 to the housing member 101 and/or the housing member 101 to the airflow disruption member 103.

As illustrated, the airflow disruption member 103 is positioned at a 90 degree angle perpendicular to the housing member 101. However, it is understood that this is for the purposes of example. In other implementations, the airflow disruption member 103 may be positioned at other degree angles perpendicular to the housing member 101, such as an 80 degree angle.

As further illustrated in FIG. 1C, the airflow disruption member 103 may be a disc that may include an airflow disruption member aperture that has a smaller diameter than the overall diameter of the airflow disruption member 103. Thus, when airflow flows from the first aperture to the second aperture and/or airflow flows from the second aperture to the first aperture, the airflow disruption member 103 may disrupt the airflow by at least partially obstructing the airflow. The airflow disruption member 103 may partially obstruct the airflow by forcing the airflow through the airflow disruption member aperture 104. This disruption may produce one or more sounds and the particular sound produced may vary depending on the speed of the airflow, the direction of the airflow (such as from the first aperture to the second aperture and/or from the second aperture to the first aperture), the angle of the airflow disruption member 103 with respect to the housing member 101, the particular positioning of the airflow disruption member 103 with respect to the first end 105 and/or the second end 106, the diameter of the airflow disruption member aperture, and/or other such factors.

For example, the pitch of the sound may depend on the diameter of the airflow disruption member aperture 104. By way of another example, the volume of the sound may depend on the angle of the airflow disruption member 103 with respect to the housing member 101.

The housing member 101 and/or the airflow disruption member 103 may be made of a variety of different kind of materials. In some implementations, the materials may include one or more thermoplastic polymers, thermoset polymers, elastomer polymers, and/or any other kind of plastic and/or polymer. In various implementations, the housing member 101 may be produced by rotation molding polyvinyl chloride (PVC) while the airflow disruption member 103 may be produced by injection molding acrylonitrile butadiene styrene (ABS).

In some cases, the housing member 101 may include a ring member (not shown) and/or other shaped protrusion from the housing member 101 into the housing member passage that braces and/or catches the airflow disruption member 103 when the airflow disruption member 103 is inserted into the housing member 101. Such a ring member may be a portion of the housing member 101 that has a smaller diameter than the rest of the housing member 101, forming a ring. Such a ring member may be formed in some implementations as part of the rotation molding process. In other implementations, the ring member may be injection molded and placed into the rotation mold during the rotation molding process such that the housing member 101 is formed around the ring member.

In still other implementations, the materials may include other such materials as one or more metals, woods, and/or other such materials. In various implementations, the housing member 101 and/or the airflow disruption member 103 may be produced by one or more kinds of polymer molding processes.

FIG. 1B is a right side plan view of the sonic stick 100 of FIG. 1A illustrating a cross section taken along the line 1-1 of FIG. 1A. FIG. 1B illustrates the internal portion of the housing member 101 as viewed through a right side play view cross-section of the sonic stick 100 taken along the line 1-1 of FIG. 1A as well as the positioning of the airflow disruption member 103 within the housing member passage 102 and the positioning of the airflow disruption member aperture 104 within the airflow disruption member 103.

As illustrated, the airflow disruption member 103 is positioned approximately equidistant from the first end 105 and the second end 106. However, it is understood that in other implementations the airflow disruption member 103 may be positioned anywhere in the housing member passage 102 between the first end 105 and the second end 106. In some implementations, the airflow disruption member 103 may be positioned proximate to either the first end 105 or the second end 106, such as within one inch of the first end 105 or the second end 106.

FIG. 1D is a bottom isometric view of the sonic stick of FIG. 1A. FIG. 1D illustrates the internal portion of the housing member 101 as viewed from a bottom isometric view of the sonic stick 100 as well as the positioning of the airflow disruption member 103 within the housing member passage 102. As illustrated, the airflow disruption member 103 is positioned approximately equidistant from the first end 105 and the second end 106. However, it is understood that in other implementations the airflow disruption member 103 may be positioned anywhere in the housing member passage 102 between the first end 105 and the second end 106. In some implementations, the airflow disruption member 103 may be positioned proximate to either the first end 105 or the second end 106, such as within one inch of the first end 105 or the second end 106.

FIG. 1E is a front plan exploded view of the sonic stick of FIG. 1A. In FIG. 1E, the airflow disruption member 103 is shown as separate from the housing member 101 and external to the housing member passage 102.

The airflow disruption member 103 is shown in FIGS. 1B-1E and described above as a flat disk including an airflow disruption member aperture 104 that is the same diameter on both sides of the airflow disruption member 103 though which the airflow disruption member aperture 102 passes. However, it is understood that this is for the purposes of example for the implementation of the sonic stick 101 and is not limiting. In other implementations, the airflow disruption member 103 may be shaped in shapes other than in disc shapes without departing from the scope of the present disclosure.

Further, in other implementations, the airflow disruption member aperture 104 may have different diameters on the different sides of the airflow disruption member 103 though which the airflow disruption member aperture 104 passes, causing the airflow disruption member aperture 104 to be angled and/or sloped as it passes through the airflow disruption member 103 without departing from the scope of the present disclosure.

Further, the sonic stick 100 is shown in FIGS. 1B-1E and described above as including a single airflow disruption member 103. However, it is understood that this is for the purposes of example for the implementation of the sonic stick 101 and is not limiting. In other implementations, multiple airflow disruption members 103 (possibly of different shapes and/or aperture diameters) may be positioned at various locations within housing member passage 102 the without departing from the scope of the present disclosure.

The housing member 101 of the sonic stick 101 is illustrated and described above as being substantially straight length-wise. However, it is understood that the housing member 101 may be shaped differently in various implementations without departing from the scope of the present disclosure. In various implementations, the sonic stick 101 may be a pet toy (such as a toy resembling a stick that produces sounds when waved in the air and/or thrown for a pet to chase), a child's toy, and/or other such device. In such implementations, the housing member 101 may be curved (such as ergonomically designed and curved to be held by a person, thrown by a person and/or designed to resemble a stick and/or other such object) or otherwise shaped in a manner other than straight length-wise.

Additionally, in various embodiments, the housing member 101 may include one or more textured outer surfaces (such as areas designed as handled including textured grips, outer surfaces including textured mimicking bark in implementations designed to resemble a stick, and other such textures). Such textures may be produced by various methods including, but not limited to, over mold processes, spray on texture processes, rotation molding processes that are used to produce the housing member 101 itself, and/or other such methods of producing textured surfaces on the housing member 101.

Furthermore, in various embodiments, the housing member 101 may include one or more hollow foam tubes such that the sonic stick 100 floats when in water. Such a hollow foam tube may be inserted into the housing member 101 such that the hollow foam tube does not interfere with airflow to and/or from the airflow disruption member 103.

Moreover, though the housing member 101 is illustrated and described as only including a single housing member passage 102, other configurations are possible without departing from the scope of the present disclosure. For example, the housing member 101 may include one or more additional hollow cylinders that are connected to the housing member 101 such that a hollow passage defined by the additional hollow cylinder may include additional first and second apertures such that the additional hollow cylinder connects with the housing member passage 102 via the first additional aperture and not the second additional aperture. In such cases, causing air to flow through the housing member passage 102 from the first aperture toward the second aperture may also cause air to flow from the first aperture through the additional hollow cylinder from the housing member passage 102 through the first additional aperture toward the second additional aperture. Additionally, in such cases, causing air to flow through the housing member passage 102 from the second aperture toward the first aperture may also cause air to flow from the second additional aperture through the additional hollow cylinder toward the first additional aperture and on into from the housing member passage 102.

In such cases, airflow disruption members may be located such that air flowing from the first additional aperture toward the second additional aperture does not pass through an airflow disruption member before the airflow passes through the first additional aperture. As such, airflow disruption members may be located in the hollow member passage 102 between the second aperture and the first additional aperture and/or within the additional hollow cylinder between the first additional aperture and the second additional aperture.

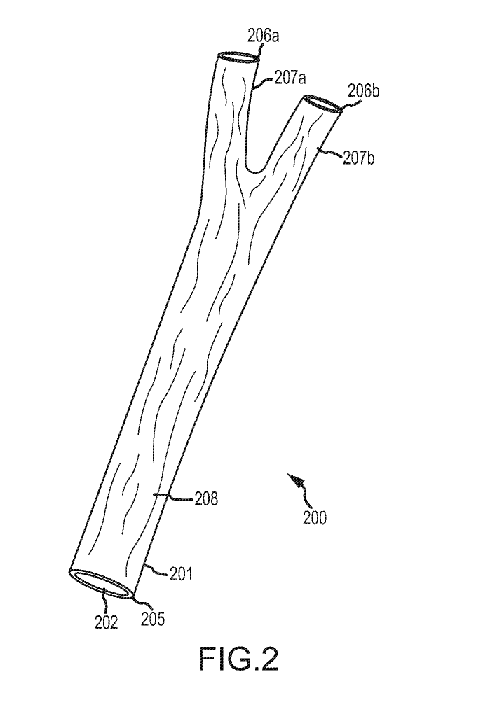

Alternatively, in such cases airflow disruption members may be located such that air flowing from the first additional aperture toward the second additional aperture passes through one or more first airflow disruption members located in the housing member passage 102 between the first aperture and the first additional aperture but not one or more second airflow disruption members located in the housing member passage 102 between the first additional aperture and the second aperture. However, in such implementations, one or more additional airflow disruption members may be located in the additional hollow cylinder between the first additional aperture and the second additional aperture. In any of these cases, such multiple airflow disruption members located in different air passages may produce a variety of sounds and/or sounds on increased volume as compared to implementations not including such multiple airflow disruption members located in different air passages. Such an implementation including an additional hollow cylinder is illustrated in FIG. 2.

FIG. 2 is an isometric front view of a second implementation of a sonic stick 200. The sonic stick 202 may include a housing member 201. The housing member 201 may be a hollow cylinder that defines a cylindrical housing member passage 202 (i.e., a hollow passage) within the housing member 201. The housing member 201, and therefore cylindrical housing member passage 202 defined by the housing member 201, may have length and width wherein the length is greater than the width. As shown, the length of the housing member 201 may be between a first end 205 and a second end 206a and 206b. Instead of including a single hollow cylinder throughout the entire length, the housing member 201 is a single cylinder 208 at the first end 205 and forks into two cylinders 207a and 207b at the second end 206a and 206b. The housing member passage 202 may connect with passages defined by the cylinders 207a and 207b such that a first aperture of both the cylinders 207a and 207b joins the housing member passage 202 and a second aperture of both the cylinders at the second end 206a and 206b does not directly connect to the housing member passage 202.

The housing member 201 may be manipulated (such as held by the first end 205 and/or the second end 206a and/or 206b and swung in an arc and/or other motion). Such manipulation may cause air to flow through the housing member passage 202 and/or the passages defined by the cylinders 207a and 207b. The manipulation may cause air to flow through the housing member passage 202 from the first aperture at the first end 205 of the housing member passage 202 toward the second apertures of the cylinders 207a and 207b at the second end 206a and/or 206b. Alternatively, the manipulation may cause air to flow through the housing member passage 202 from the second apertures of the cylinders 207a and 207b at the second end 206a and/or 206b toward the first aperture at the first end 205 of the housing member passage 202.

One or more airflow disruption members (such as the airflow disruption member 103 shown in FIGS. 1B-1E) may be positioned within the housing member passage 202 and/or one or more of the passages defined by the cylinders 207a and 207b. The airflow disruption members may be positioned such that airflow from the first aperture to one or both of the second apertures of the cylinders 207a and 207b is disrupted and/or airflow from one or both of the second apertures of the cylinders 207a and 207b to the first aperture is disrupted. Such disruption of the airflow may produce one or more sounds. Such disrupted airflow may produce sounds in a similar manner to the operation of a whistle.

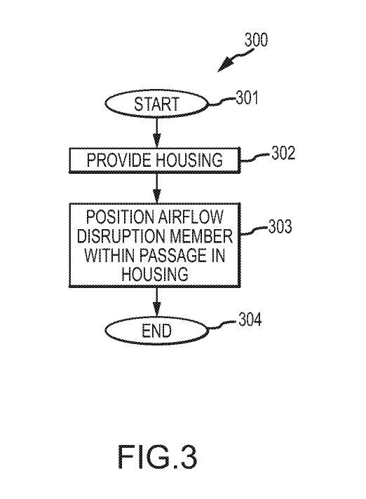

FIG. 3 illustrates a method 300 for providing a sonic stick, such as the sonic stick 100 and/or the sonic stick 200. The flow begins at block 301 and proceeds to block 302 where a housing member is provided. The housing member may include at least one hollow cylinder that defines a cylindrical housing member passage within the housing member. The at least one hollow cylinder may have a length and width wherein the length is greater than the width. The at least one hollow cylinder may include at least a first aperture at a first end of the housing member passage and at least a second aperture at a second end of the housing member passage. The first end of the housing member passage may be positioned at a first end of the length of the at least one hollow cylinder and the second end of the housing member passage may be positioned at a second end of the length of the at least one hollow cylinder. The flow then proceeds to block 303.

At block 303, at least one airflow disruption member is positioned within the housing member passage such that airflow from the first aperture to the second aperture may be disrupted. The at least one airflow disruption member may disrupt airflow when the housing member is manipulated to cause air to flow through the housing member passage from the first aperture to the second aperture. This disruption of the airflow may produce at least one sound. The flow then proceeds to block 304 and ends.

Although the method 300 is illustrated and described as including particular operations performed in a particular order, the operations may be performed in a different order and additional operations may be performed without departing from the scope of the present disclosure. For example, though operations 302 and 303 are illustrated and described as separate, linearly performed operations, in various implementations operations 302 and 303 may be performed simultaneously, consecutively, and/or substantially simultaneously and/or consecutively. Additionally, the method 300 may include additional operations such as one or more processes to shape the housing member, decorate the housing member, add one or more textures to the housing member, configuring the housing member such that the sonic stick floats in water (such as inserting one or more hollow foam tubes into the housing member between and end of the housing member and the airflow disruption member, inserting one or more hollow foam tubes into the housing member between airflow disruption members, otherwise inserting one or more foam tubes, constructing the housing member from a buoyant material, adding a buoyant collar to the housing member, and/or any other such means of causing the sonic stick to be buoyant), and/or other such additional operations. The particular operations and order of operations illustrated and described with respect to the method 300 are for the purposes of example.

In some implementations, the operation 302 of providing a housing member may include producing a housing member by rotation molding. Liquid PVC may be placed into a mold and spun such that centrifugal force produced one or more hollow cylinders. Such a mold may be textured such that the outer surface of such a housing member is textured. For example, the texture may resemble the bark of a branch.

In various implementations, the operation 303 of positioning at least one airflow disruption member is within the housing member passage may include producing the at least one airflow disruption member by injection molding ABS. The injection molded ABS airflow disruption member may then be inserted into the housing member. In such cases, the housing member may be heated in order to expand the housing member before insertion of the airflow disruption member. Additionally, glue and/or other sealant may be applied to the airflow disruption member before the airflow disruption member is inserted into the housing member, after the airflow disruption member is inserted into the housing member, and/or while the airflow disruption member is inserted into the housing member.

In one or more implementations, the operation 303 of positioning at least one airflow disruption member is within the housing member passage may include bracing the airflow disruption member against a ring and/or other shape member protruding from the housing member into the housing member passage. Such a ring and/or other shaped member may be produced as part of rotation molding the housing member, by injection molding and placed into the rotation mold for the housing member such that the housing member is formed around the ring and/or other shaped member, and/or otherwise produced.

In the present disclosure, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A sonic stick apparatus, comprising:
a housing member comprising at least one hollow tube that defines a tube housing member passage within the housing member, the at least one hollow tube having a length and width wherein the length is greater than the width, the at least one hollow tube including at least a first aperture at a first end of the housing member passage and at least a second aperture at a second end of the housing member passage, the first end of the housing member passage positioned at a first end of the length of the at least one hollow tube and the second end of the housing member passage positioned at a second end of the length of the at least one hollow tube; and
at least one airflow disruption member positioned within the housing member passage such that airflow from the first aperture to the second aperture is disrupted;
wherein the at least one airflow disruption member disrupts airflow when the housing member is manipulated to cause air to flow through the housing member passage from the first aperture to the second aperture and the disruption of the airflow produces at least one sound.

2. The sonic stick apparatus of claim 1, wherein the sonic stick apparatus comprises a pet toy.

3. The sonic stick apparatus of claim 1, wherein the at least one airflow disruption member comprises at least one disc that includes at least one disc aperture.

4. The sonic stick apparatus of claim 3, wherein the at least one disc is positioned within the housing member passage such that at least a portion of the airflow is forced to pass through the at least one disc aperture.

5. The sonic stick apparatus of claim 3, wherein the at least one disc is positioned within the housing member passage at an angle perpendicular to length of the at least one hollow tube.

6. The sonic stick apparatus of claim 1, wherein the sonic stick apparatus is configured to float in water.

7. The sonic stick apparatus of claim 1, wherein the at least one airflow disruption member disrupts airflow when the housing member is manipulated to cause air to flow through the housing member passage from the second aperture to the first aperture and the disruption of the airflow when the housing member is manipulated to cause air to flow through the housing member passage from the second aperture to the first aperture produces at least one additional sound.

8. The sonic stick apparatus of claim 7, wherein the at least one additional sound is a different sound than the at least one sound.

9. The sonic stick apparatus of claim 1, wherein at least one of the housing member includes at least one textured outer surface or the housing member is curved.

10. The sonic stick apparatus of claim 1, wherein the housing member is ergonomically shaped to be at least one of held by a person or thrown by a person.

11. The sonic stick apparatus of claim 1, wherein at least one of the housing member is made of polyvinyl chloride or the at least one airflow disruption member is made of acrylonitrile butadiene styrene.

12. The sonic stick apparatus of claim 1, wherein the housing member further includes:
at least one additional hollow tube that defines at least one additional tube passage within the at least one additional hollow tube, the at least one additional hollow tube includes at least one first additional hollow tube aperture at a first end of the at least one additional hollow tube and at least one second additional hollow tube aperture at a second end at least one additional hollow tube, the first end of the at least one additional hollow tube positioned such that the first additional hollow tube aperture connects the at least one additional tube passage with the tube housing member passage; and
at least one additional airflow disruption member positioned within the at least one additional tube passage such that airflow from the first additional hollow tube aperture to the additional hollow tube second aperture is disrupted;
wherein the at least one additional airflow disruption member disrupts airflow when the housing member is manipulated to cause air to flow through the at least one additional tube passage from the first additional hollow tube aperture to the second additional hollow tube aperture and the disruption of the airflow from the first additional hollow tube aperture to the second additional hollow tube aperture produces at least one additional sound.

13. The sonic stick apparatus of claim 12, wherein when the housing member is manipulated to cause air to flow through the at least one additional tube passage from the first additional hollow tube aperture to the second additional hollow tube aperture the air that flows through the at least one additional tube passage first flowed through the tube housing member passage.

14. The sonic stick apparatus of claim 13, wherein the at least one airflow disruption member is positioned between the second end of the housing member passage and the first additional hollow tube aperture.

15. The sonic stick apparatus of claim 13, wherein the at least one airflow disruption member is positioned between the first end of the housing member passage and the first additional hollow tube aperture.

16. The sonic stick apparatus of claim 1, wherein when the housing member is manipulated to cause air to flow through the housing member passage from the first aperture to the second aperture at a first speed a first sound is produced and when the housing member is manipulated to cause air to flow through the housing member passage from the first aperture to the second aperture at a second speed a second sound is produced wherein the first sound and second sound are different sounds.

17. A method of providing a sonic stick apparatus, comprising:
providing a housing member comprising at least one hollow tube that defines a tube housing member passage within the housing member, the at least one hollow tube having a length and width wherein the length is greater than the width, the at least one hollow tube including at least a first aperture at a first end of the housing member passage and at least a second aperture at a second end of the housing member passage, the first end of the housing member passage positioned at a first end of the length of the at least one hollow tube and the second end of the housing member passage positioned at a second end of the length of the at least one hollow tube; and
positioning at least one airflow disruption member within the housing member passage such that airflow from the first aperture to the second aperture is disrupted wherein the at least one airflow disruption member disrupts airflow when the housing member is manipulated to cause air to flow through the housing member passage from the first aperture to the second aperture and the disruption of the airflow produces at least one sound.

18. The method of claim 19, wherein at least one of:
said operation of providing a housing member comprising at least one hollow tube that defines a tube housing member passage within the housing member further comprises:
producing the housing member by rotation molding; or
said operation of positioning at least one airflow disruption member within the housing member passage such that airflow from the first aperture to the second aperture is disrupted further comprises:
producing the at least one airflow disruption member utilizing injection molding.

19. The method of claim 19, wherein said operation of positioning at least one airflow disruption member within the housing member passage such that airflow from the first aperture to the second aperture is disrupted further comprises: inserting the at least one airflow disruption member into the housing member passage.

20. A pet toy sonic stick apparatus, comprising:
a housing member comprising at least one hollow tube that defines a tube housing member passage within the housing member, the at least one hollow tube having a length and width wherein the length is greater than the width, the at least one hollow tube including at least a first aperture at a first end of the housing member passage and at least a second aperture at a second end of the housing member passage, the first end of the housing member passage positioned at a first end of the length of the at least one hollow tube and the second end of the housing member passage positioned at a second end of the length of the at least one hollow tube; and
at least one airflow disruption member comprising at least one disc that includes at least one disc aperture, the at least one disc positioned within the housing member passage such that airflow from the first aperture to the second aperture is disrupted;
wherein the at least one airflow disruption member disrupts airflow by forcing the airflow to pass through the at least one disc aperture when the housing member is manipulated to cause air to flow through the housing member passage from the first aperture to the second aperture and the disruption of the airflow produces at least one sound.
